(19) United States
(12) Patent Application Publication
(10) Pub. No.: US 2008/0075185 A1
(43) Pub. Date: Mar. 27, 2008

(54) SIGNAL TRANSMISSION/RECEPTION APPARATUS AND METHOD TO MINIMIZE INTER-CELL INTERFERENCE IN A COMMUNICATION SYSTEM

(75) Inventors: Sung-Woo PARK, Suwon-si (KR); June Moon, Seoul (KR)

Correspondence Address: Jefferson IP Law, LLP, 1730 M Street, NW, Suite 807, Washington, DC, 20036, US

(73) Assignee: Samsung Electronics Co., LTD., Suwon-city (KR)

(21) Appl. No.: 11/859,068

(22) Filed: Sep. 21, 2007

(30) Foreign Application Priority Data
Sep. 27, 2006 (KR) 10-2006-94181

(51) Int. Cl. H04B 1/66

(52) U.S. Cl. 375/260

(57) ABSTRACT

An apparatus and method to transmit/receive a signal in a communication system are provided. A base station (BS) generates repetitive information by repeating information a number of times, allocates a subcarrier for transmitting the repetitive information using a subcarrier allocation scheme that all BSs included in the communication system use in a same way, and transmits the repetitive information using the allocated subcarrier. When the communication system includes a serving BS and one interference BS, a mobile station (MS) detects R-times repeated information from a corresponding subcarrier of a signal received via K reception antennas, estimates a channel using the received signal, reassembles the detected information, and performs R×2×k Minimum Mean Square Error (MMSE) processing on the reassembled information using the channel-estimated value.

### PRIORITY

This application claims the benefit under 35 U.S.C. § 119(a) of a Korean patent application filed in the Korean Intellectual Property Office on Sep. 27, 2006 and assigned Serial No. 2006-94181, the entire disclosure of which is hereby incorporated by reference.

### BACKGROUND OF THE INVENTION

1. Field of the Invention

The present invention relates generally to an apparatus and method to transmit/receive signals in a communication system. More particularly, the present invention relates to a signal transmission/reception apparatus and method to minimize Inter-Cell Interference (ICI).

2. Description of the Related Art

A next generation communication system is developing into a mobile communication system for providing Mobile Stations (MSs) with a service in which high-speed, high-capacity data transmission/reception is possible. An Institute of Electrical and Electronics Engineers (IEEE) 802.16e communication system, which is hereby incorporated by reference, is an example of the next generation communication system. The IEEE 802.16e communication system positively considers using a frequency reuse factor of 1. However, although the use of the frequency reuse factor of 1 increases an amount of frequency resources available in one cell and contributes to an increase in efficiency of the frequency resources, it causes ICI due to the identity of frequency resources, i.e. subcarriers, between a serving BS and a neighbor BS in a cell overlapping region. Due to the ICI, an MS located in a cell overlapping region may suffer from a reduction in performance of receiving signals transmitted by the serving BS.

To compensate for the reduction in the MS reception performance in the cell overlapping region, the IEEE 802.16e communication system modulates and codes high-priority information, such as common control information, using the most robust Modulation and Coding Scheme (MCS) level available therein. For convenience, it will be assumed herein that the high-priority information is the common control information.

The common control information may include Frame Control Header (FCH) and MAP information. The MAP information includes a downlink MAP (DL-MAP) message and an uplink MAP (UL-MAP) message, and the most robust MCS levels used by all BSs of the IEEE 802.16e communication system are substantially identical to each other.

The FCH includes basic information on subchannel, ranging and modulation scheme. The MAP information includes location information for downlink burst fields and uplink burst fields, modulation scheme information, and allocation information of the downlink burst fields and the uplink burst fields, i.e. information indicating whether the downlink burst fields and the uplink burst fields are allocated to a particular MS on a dedicated basis, or allocated to multiple unspecified MSs in common.

The IEEE 802.16e communication system repeatedly transmits the FCH and the MAP information. In this case, the FCH can be repeatedly transmitted a maximum of 4 times after undergoing modulation and coding with Quadrature Phase Shift Keying (QPSK) 1/2, and the MAP information can be repeatedly transmitted a maximum of 6 times after undergoing modulation and coding with QPSK 1/2.

Even though the IEEE 802.16e communication system transmits the FCH and MAP information using the most robust MCS level available therein in this manner, the MS located in the cell overlapping region cannot meet the reception performance required in the IEEE 802.16e communication system. Therefore, in order to cancel the ICI, the IEEE 802.16e communication system includes separate interference cancellation schemes, for example, Successive Interference Cancellation (SIC) scheme and Minimum Mean Square Error (MMSE) scheme.

The SIC scheme detects an interference signal, regenerates a received signal depending on the interference, and then detects a desired signal by subtracting the regenerated received signal from the actually received signal. The MMSE scheme detects a designed signal without performing detection and regeneration for an interference signal, by multiplying a received signal by an MMSE weight. The SIC scheme is superior in performance to the MMSE scheme. However, because the SIC scheme greatly varies in its performance depending on a scope of a Signal-to-Interference and Noise Ratio (SINR) and has high complexity, the MMSE scheme is generally used.

As described above, the IEEE 802.16e communication system can repeatedly transmit the FCH a maximum of 4 times, can repeatedly transmit the MAP information a maximum of 6 times, and uses the MMSE scheme for ICI cancellation. However, the current IEEE 802.16e communication system considers using only the MMSE scheme to increase ICI cancellation performance. For the case where repetitive codes such as the FCH and the MAP information are used together with the MMSE scheme, the IEEE 802.16e communication system considers no detailed subcarrier allocation scheme for increasing ICI cancellation performance.

### SUMMARY OF THE INVENTION

An aspect of the present invention is to address at least the above-mentioned problems and/or disadvantages and to provide at least the advantages described below. Accordingly, an aspect of the present invention is to provide a signal transmission/reception apparatus and method to minimize ICI in a communication system.

Another aspect of the present invention is to provide an apparatus and method in which all BSs transmit/receive signals according to the same subcarrier allocation pattern in a communication system.

According to one aspect of the present invention, an apparatus to transmit a signal of a base station (BS) in a communication system is provided. The signal transmission apparatus includes a repetitive information generator to generate repetitive information by repeating information a number of times, a subcarrier allocator to allocate a subcarrier for transmitting the repetitive information using a subcarrier allocation scheme that all BSs included in the communication system use in a same way, and a transmitter to transmit the repetitive information using the allocated subcarrier.

According to another aspect of the present invention, an apparatus to receive a signal in a mobile station (MS) of a communication system is provided. The signal reception apparatus includes an information detector to, when the communication system includes a serving BS and one interference BS, detect R-times repeated information from a corresponding subcarrier of a signal received via K reception antennas, a channel estimator to estimate a channel using the received signal, an information reassembler to reassemble the detected information, and an Minimum Mean Square Error (MMSE) unit to perform R×2×k MMSE processing on the reassembled information using the channel-estimated value.

According to further another aspect of the present invention, a method to transmit a signal in a base station (BS) of a communication system is provided. The signal transmission method includes generating repetitive information by repeating information a number of times, allocating a subcarrier for transmitting the repetitive information using a subcarrier allocation scheme that all BSs included in the communication system use in a same way, and transmitting the repetitive information using the allocated subcarrier.

According to yet another aspect of the present invention, a method to receive a signal in a mobile station (MS) of a communication system is provided. The signal reception method includes, when the communication system includes a serving BS and one interference BS, detecting R-times repeated information from a corresponding subcarrier of a signal received via K reception antennas, estimating a channel using the received signal, reassembling the detected information, and performing R×2×k Minimum Mean Square Error (MMSE) processing on the reassembled information using the channel-estimated value.

### BRIEF DESCRIPTION OF THE DRAWINGS

The above and other aspects, features and advantages of certain exemplary embodiments of the present invention will become more apparent from the following detailed description when taken in conjunction with the accompanying drawings in which:

FIG. 1 is a schematic diagram illustrating a configuration of an IEEE 802.16e communication system according to an exemplary embodiment of the present invention;

FIG. 2 is a diagram illustrating a structure of a frame for an IEEE 802.16e communication system according to an exemplary embodiment of the present invention;

FIG. 3 is a schematic diagram illustrating a subcarrier allocation operation based on an M-PUSC scheme for a case where FCH is repeatedly transmitted 4 times and MAP information is repeatedly transmitted 6 times, according to an exemplary embodiment of the present invention;

FIG. 4 is a schematic diagram illustrating a subcarrier allocation operation based on an M-PUSC scheme for a case where FCH is repeatedly transmitted 4 times and MAP information is repeatedly transmitted 4 times, according to an exemplary embodiment of the present invention;

FIG. 5 is a schematic diagram illustrating an operation of allocating subcarriers based on an M-PUSC scheme in an IEEE 802.16e communication system according to an exemplary embodiment of the present invention; and

FIG. 6 is a diagram illustrating a structure of a signal reception apparatus of an MS in an IEEE 802.16e communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and configurations are omitted for clarity and conciseness.

The present invention provides a signal transmission/reception apparatus and method to minimize Inter-Cell Interference (ICI) in a communication system. In particular, the present invention provides an apparatus and method in which all Base Stations (BSs) each allocate subcarriers so as to minimize the ICI occurring for the high-priority information such as common control information that all Mobile Stations (MSs) should receive in common, in a communication system. In addition, the present invention provides a reception apparatus and method to maximize ICI cancellation performance for the high-priority information such as the common control information that all BSs each have transmitted to minimize the ICI, in a communication system. Although the following description will be made herein with reference to an Institute of Electrical and Electronics Engineers (IEEE) 802.16e communication system, by way of example, the subcarrier allocation apparatus and method provided by the present invention can be applied not only to the IEEE 802.16e communication system, but also to other communication systems. In the IEEE 802.16e communication system, the common control information may include Frame Control Header (FCH) and MAP information. The MAP information includes a downlink MAP (DL-MAP) message and an uplink MAP (UL-MAP) message. For convenience, it will be assumed herein that the high-priority information is the conventional control information.

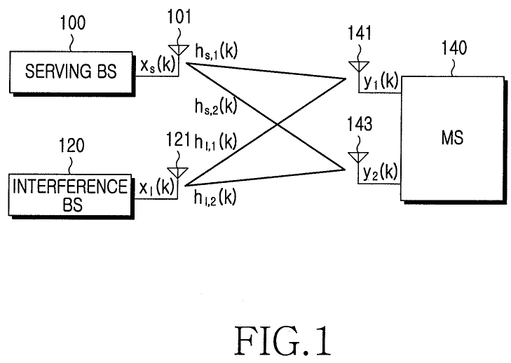

FIG. 1 is a schematic diagram illustrating a configuration of an IEEE 802.16e communication system according to an exemplary embodiment of the present invention.

Referring to FIG. 1, the IEEE 802.16e communication system includes a serving BS 100 which uses an antenna 101, an interference BS 120 which uses an antenna 121, or a neighbor BS exerting an ICI influence on the serving BS 100, among neighbor BSs and an MS 140.

The IEEE 802.16e communication system repeatedly transmits the common control information a number of times, and uses a Minimum Mean Square Error (MMSE) scheme for ICI cancellation. For example, the IEEE 802.16e communication system can repeatedly transmit the FCH a maximum of 4 times, and can repeatedly transmit the MAP information a maximum of 6 times. The combined use of the FCH and the MAP information, for which repetitive codes are used, and of the MMSE scheme can efficiently cancel the ICI, compared to the use of the conventional MMSE scheme, and a detailed description thereof will be made below. For convenience, the MMSE scheme to which the repetitive codes are applied will be referred to herein as a ‘repetitive code-MMSE scheme’ or ‘repetitive code-based MMSE scheme’.

It will be assumed herein that the MS 140 uses two reception antennas 141 and 143, there is only one interference cell, i.e. there is only the interference BS 120, and the MAP information is repeatedly transmitted 4 times. In this case, the conventional MMSE scheme detects a Log Likelihood Ratio (LLR) using a 2×2 MMSE receiver for each repetition of the MAP information, and detects a final LLR by adding up the 4 detected LLRs. However, the repetitive code-MMSE scheme, assuming that the signal received through 4 repetitions is a signal received at a virtual reception antenna, detects an LLR using an 8×2 MMSE receiver. As described above, while the conventional MMSE scheme acquires only the gain that reception power increases 4 times, the repetitive code-MMSE scheme acquires not only the gain that the reception power increases 4 times, but also an additional gain by virtual spatial diversity. In this way, the repetitive code-MMSE scheme, compared to the conventional MMSE scheme, is high in the acquirable gain and equal in calculation, thereby obtaining a gain in terms of the complexity.

However, in order for the repetitive code-MMSE scheme to be efficiently performed, the serving BS and the interference BS should use the same subcarrier allocation pattern for the subchannel over which the common control information is transmitted. For convenience, the subchannel over which the common control information is transmitted will be referred to herein as a ‘common control subchannel’. However, the current IEEE 802.16e communication system does not consider a separate subcarrier allocation scheme for use of the repetitive code-MMSE scheme. Therefore, the present invention provides a subcarrier allocation scheme for use of the repetitive code-MMSE scheme.

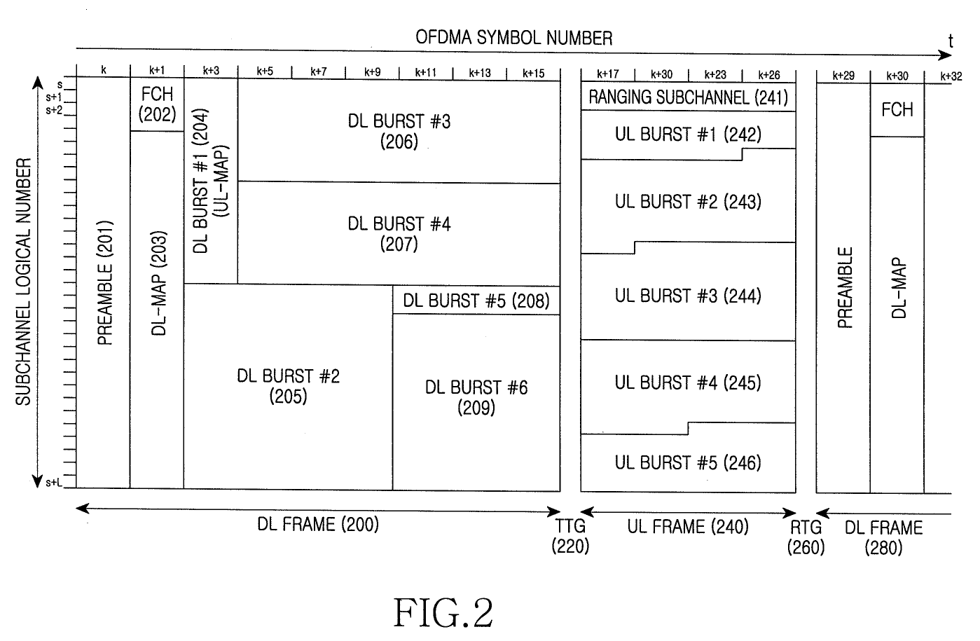

FIG. 2 is a diagram illustrating a structure of a frame for an IEEE 802.16e communication system according to an exemplary embodiment of the present invention.

Referring to FIG. 2, the horizontal axis indicates Orthogonal Frequency Division Multiple Access (OFDMA) symbol numbers, and the vertical axis indicates subchannel logical numbers. As shown in FIG. 2, one OFDMA frame includes multiple OFDMA symbols and multiple subchannels. The OFDMA frame includes a downlink (DL) frame 200 and an uplink (UL) frame 240, and switching from the downlink frame 200 to the uplink frame 240 is performed during a Transmit/receive Transition Gap (TTG) 220. In addition, switching from the uplink frame 240 to a downlink frame 280 is performed during a Receive/transmit Transition Gap (RTG) 260.

The downlink frame 200 includes a preamble field 201, an FCH field 202, a DL-MAP field 203, and multiple downlink burst (DL burst) fields, i.e. DL burst-#1 field 204, DL burst-#2 field 205, DL burst-#3 field 206, DL burst-#4 field 207, DL burst-#5 field 208 and DL burst-#6 field 209.

The preamble field 201 is a field over which a synchronization signal, or a preamble, for synchronization acquisition between a transmitter and a receiver is transmitted. The FCH field 202 is a field over which basic information on subchannel, ranging and modulation scheme is transmitted. The DL-MAP field 203 is a field over which a DL-MAP message is transmitted. A UL-MAP message is transmitted over the DL burst-#1 field 204 among the DL burst fields.

The uplink frame 240 includes a ranging subchannel field 241, and multiple uplink burst (UL burst) fields, i.e. UL burst-#1 field 242, UL burst-#2 field 243, UL burst-#3 field 244, UL burst-#4 field 245 and UL burst-#5 field 246. The ranging subchannel field 241 is a field over which a ranging subchannel signal for ranging is transmitted.

The current IEEE 802.16e communication system uses a Partial Usage of SubChannel (PUSC) scheme-based subchannel in the FCH field 202 and the DL-MAP field 203. For convenience, a subchannel generated with the PUSC scheme will be referred to as a ‘PUSC subchannel’. In addition, a PUSC scheme-based subcarrier allocation pattern is determined according to a permutation sequence used for a PUSC structure in a corresponding BS, and this permutation sequence is determined according to a cell identifier (ID) of the BS. Therefore, when cell IDs allocated to individual BSs are different from each other, PUSC scheme-based subcarrier allocation patterns of the BSs are different from each other. When the individual BSs are different from each other in the PUSC scheme-based subcarrier allocation pattern in this way, they have a difficulty in using the repetitive code-MMSE scheme. Therefore, an exemplary embodiment of the present invention proposes to use a Modified (M)-PUSC scheme-based subchannel other than the PUSC scheme-based subchannel, for the FCH field 202 and the DL-MAP field 203. For convenience, the subchannel generated with the M-PUSC scheme will be referred to herein as an ‘M-PUSC subchannel’.

A description of the M-PUSC scheme will now be made below.

A number of pilot subcarriers and data subcarriers in the M-PUSC scheme are equal to a number of pilot subcarriers and data subcarriers in the PUSC scheme. However, while 1 slot is configured to occupy a 2-OFDMA symbol interval in the PUSC scheme, 1 slot is configured to occupy a 1-OFDMA symbol interval in the M-PUSC scheme. Further, in the M-PUSC scheme, there is no separate subchannel therein, and data is directly allocated to data subcarriers of the M-PUSC subchannel. That is, symbols generated after channel coding, repetition and modulation are classified into 48-symbol slots, and then mapped to the data subcarriers of the M-PUSC subchannel. A description will now be made of a scheme of allocating subcarriers for FCH and MAP information using the M-PUSC scheme. It will be assumed herein that the FCH is repeatedly transmitted 4 times.

(1) Symbols, or FCH symbols, of an i^{th} slot (i=0, 1, 2, 3) of the FCH field 202 are sequentially allocated to data subcarrier indexes Ndata_subcarriers/4*i through Ndata_subcarriers/4*i+47 of a first OFDMA symbol of the M-PUSC subchannel. The data subcarrier index will be referred to herein as ‘k’.

(2) Indexes (k=0˜(Ndata_subcarriers−1)−4*48) are re-assigned for the remaining data subcarriers except for the data subcarriers previously allocated in the first OFDMA symbol of the M-PUSC subchannel.

(3) R segments are generated by dividing the data subcarriers re-assigned the indexes into as many segments as the number R of repetitions for MAP information.

(4) Symbols, or MAP symbols, included in the original MAP information before repetition are sequentially allocated to a first segment of a first OFDMA symbol of the M-PUSC subchannel. The same MAP message symbols as those of the first segment are copied and allocated to the remaining segments of the first OFDMA symbol of the M-PUSC subchannel.

(5) When the allocation of the MAP symbols has not been completed in the first OFDMA symbol of the M-PUSC subchannel, MAP symbols are allocated in the same way for the next OFDMA symbol.

The foregoing M-PUSC scheme is used in the same way both in the serving BS and the interference BS, and when subcarriers for transmitting common control information are allocated according to the M-PUSC scheme, the repetitive code-MMSE scheme, if used, improves in its ICI cancellation performance.

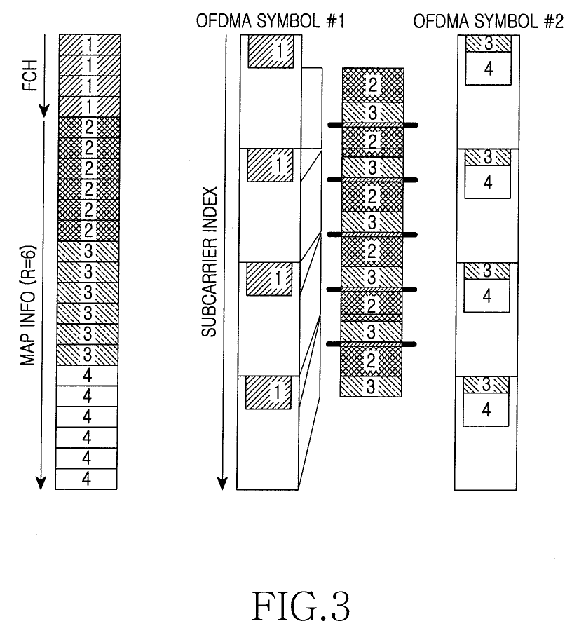

With reference to FIG. 3, a description will now be made of a subcarrier allocation operation based on the M-PUSC scheme for the case where FCH is repeatedly transmitted 4 times and MAP information is repeatedly transmitted 6 times.

FIG. 3 is a schematic diagram illustrating a subcarrier allocation operation based on an M-PUSC scheme for a case where FCH is repeatedly transmitted 4 times and MAP information is repeatedly transmitted 6 times, according to an exemplary embodiment of the present invention.

Referring to FIG. 3, 4 FCH symbols included in FCH are sequentially allocated to Ndata_subcarriers/4*i through Ndata_subcarriers/4*i+47 of a first OFDMA symbol (OFDMA symbol #1), and then, the other subcarriers except for the subcarriers to which the 4 FCH symbols are allocated, are divided into 6 segments. In addition, MAP information before repetition, i.e., 3 MAP symbols, are sequentially allocated to a first segment among the 6 segments of the first OFDMA symbol. However, because the 3 MAP symbols cannot all be allocated to the first segment of the first OFDMA symbol, they are allocated even to a first segment of a second OFDMA symbol (OFDMA symbol #2). As for the second OFDMA symbol, because no FCH symbol is transmitted over it, only MAP symbols are directly allocated thereto.

The MAP symbols allocated to the first segment are copied and allocated intact to the remaining 5 segments except for the first segment among the 6 segments of the first OFDMA symbol. Similarly, the MAP symbols allocated to the first segment are copied and allocated intact to the remaining 5 segments except for the first segment among the 6 segments of the second OFDMA symbol.

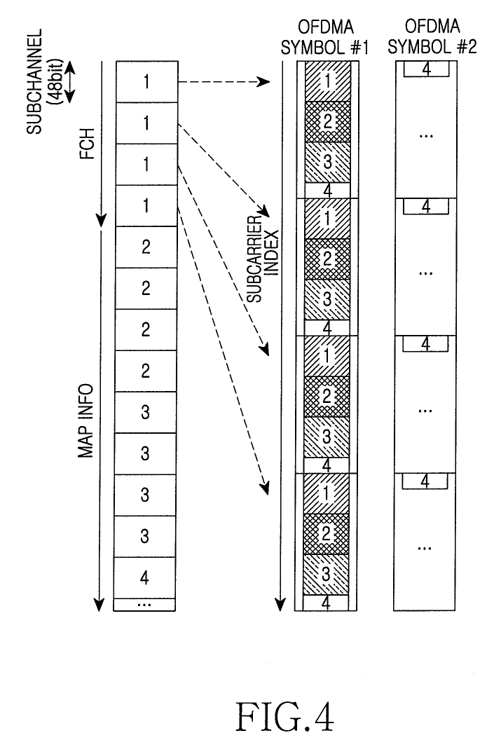

With reference to FIG. 4, a description will now be made of a subcarrier allocation operation based on the M-PUSC scheme for the case where FCH is repeatedly transmitted 4 times and MAP information is repeatedly transmitted 4 times.

FIG. 4 is a schematic diagram illustrating a subcarrier allocation operation based on an M-PUSC scheme for a case where FCH is repeatedly transmitted 4 times and MAP information is repeatedly transmitted 4 times, according to an exemplary embodiment of the present invention.

Referring to FIG. 4, 4 FCH symbols included in FCH are sequentially allocated to Ndata_subcarriers/4*i through Ndata_subcarriers/4*i+47 of a first OFDMA symbol (OFDMA symbol #1), and then, the other subcarriers except for the subcarriers to which the 4 FCH symbols are allocated, are divided into 4 segments. In addition, MAP information before repetition, i.e., 3 MAP symbols, are sequentially allocated to a first segment among the 4 segments of the first OFDMA symbol. However, because the 3 MAP symbols cannot all be allocated to the first segment of the first OFDMA symbol, they are allocated even to a first segment of a second OFDMA symbol (OFDMA symbol #2). As for the second OFDMA symbol, because no FCH symbol is transmitted over it, only MAP symbols are directly allocated thereto.

The MAP symbols allocated to the first segment are copied and allocated intact to the remaining 3 segments except for the first segment among the 4 segments of the first OFDMA symbol. Similarly, the MAP symbols allocated to the first segment are copied and allocated intact to the remaining 3 segments except for the first segment among the 4 segments of the second OFDMA symbol.

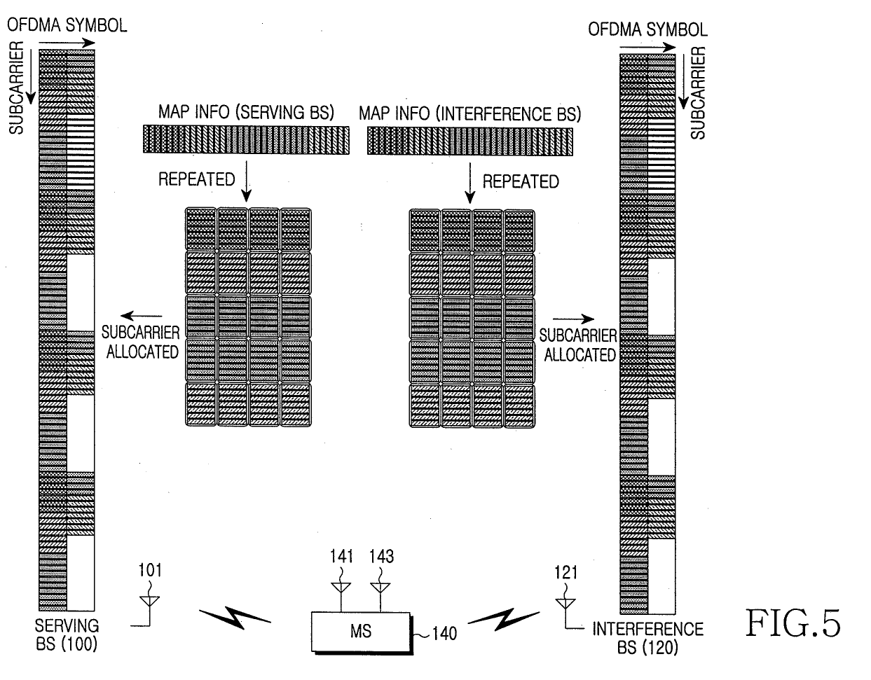

With reference to FIG. 5, a description will now be made of an operation of an IEEE 802.16e communication system when it allocates subcarriers based on the M-PUSC scheme.

FIG. 5 is a schematic diagram illustrating an operation of allocating subcarriers based on an M-PUSC scheme in an IEEE 802.16e communication system according to an exemplary embodiment of the present invention.

Before a description of FIG. 5 is given, it should be noted that the present invention maximizes ICI cancellation performance when all BSs use the repetitive code-MMSE scheme as they transmit the common control information using the M-PUSC scheme. Shown in FIG. 5 is an operation of applying the M-PUSC scheme to the MAP information out of the common control information. That is, in FIG. 5, a serving BS 100 and a neighbor BS 120 transmit MAP information with the M-PUSC scheme. In this case, ICI cancellation performance improves because ICI exists uniformly in all subcarriers allocated for transmission of the MAP information.

In addition, when the M-PUSC scheme is used, relative positions of the MAP symbols are always constant, and are distributed over the entire frequency band used in the IEEE 802.16e communication system, thus making it possible to maximize a frequency diversity effect. In addition, when the MMSE scheme detects a weight, it can reuse the weight as much as a coherent bandwidth, contributing to a decrease in the implementation complexity. Finally, when the M-PUSC scheme is used, subcarriers are allocated per OFDMA symbol, contributing to an increase in flexibility of system operation.

Although not described with reference to a separate drawing, a structure of a signal transmission apparatus of a BS in the IEEE 802.16e communication system is similar to a structure of a signal transmission apparatus of a BS in the conventional IEEE 802.16e communication system, and the new signal transmission apparatus is simply different from the conventional signal transmission apparatus which transmits the common control information by using the M-PUSC scheme. That is, the signal transmission apparatus includes a common control information generator for generating common control information, a subcarrier allocator for allocating subcarriers for transmitting the common control information, and a transmitter for transmitting the common control information over the allocated subcarriers, and the subcarrier allocator allocates subcarriers for transmitting the common control information, according to the M-PUSC scheme.

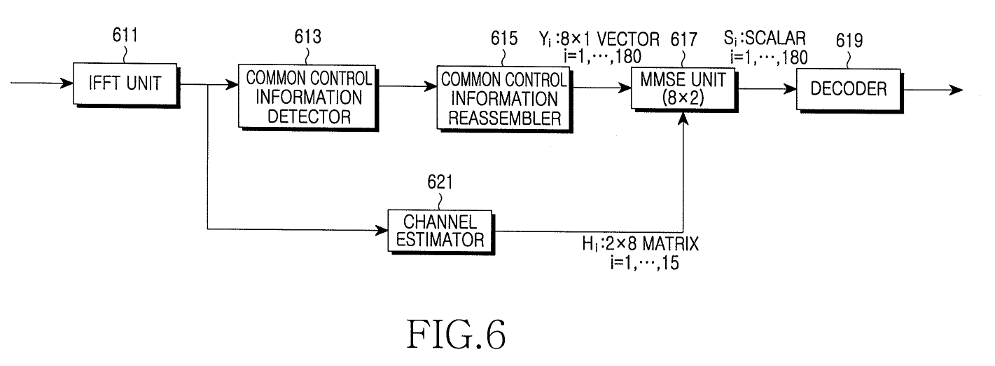

With reference to FIG. 6, a description will now be made of a structure of a signal reception apparatus of an MS in an IEEE 802.16e communication system according to an embodiment of the present invention.

FIG. 6 is a diagram illustrating a structure of a signal reception apparatus of an MS in an IEEE 802.16e communication system according to an exemplary embodiment of the present invention.

Before a description of FIG. 6 is given, it will be assumed that the signal transmission apparatus has repeatedly transmitted the common control information 4 times and the signal reception apparatus uses 2 reception antennas.

Referring to FIG. 6, the signal reception apparatus includes an Inverse Fast Fourier Transform (IFFT) unit 611, a common control information detector 613, a common control information reassembler 615, an MMSE unit 617, a decoder 619 and a channel estimator 621.

A signal received via the 2 reception antennas is delivered to the IFFT unit 611, and the IFFT unit 611 performs IFFT on the received signal, and outputs a resulting signal to the common control information detector 613 and the channel estimator 621. The common control information detector 613 detects common control information from the received signal from the IFFT unit 611 according to the M-PUSC scheme, and outputs the detected common control information to the common control information reassembler 615. The common control information reassembler 615 reassembles the common control information output from the common control information detector 613, and outputs the resulting signal to the MMSE unit 617. The signal output from the common control information reassembler 615 is denoted herein by Yᵢ, where i=1, 2, . . . , 180. The parameter i indicates a subcarrier index and the signal Yᵢ is an 8×1 vector.

The channel estimator 621 performs channel estimation on the signal output form the IFFT unit 611, and outputs a channel matrix indicating the channel to the MMSE unit 617. The channel matrix is denoted herein by Hᵢ, where i=1, 2, . . . , 15. The parameter i indicates a slot index, and the channel matrix Hᵢ is a 2×8 matrix.

The MMSE unit 617 performs MMSE processing on the signal output from the common control information reassembler 615 and the signal output from the channel estimator 621, and outputs the resulting signal to the decoder 619. In other words, assuming the signal transmitted with a repetitive code as a signal received at a virtual reception antenna, the MMSE unit 617 performs 8×2 MMSE processing on the received signal to detect an LLR, and outputs the detected LLR to the decoder 619. In this case, because the MMSE unit 617 assumes the signal transmitted with a repetitive code as a signal received at a virtual reception antenna, and performs MMSE processing thereon as described above, it can acquire the reception power gain as well as the frequency diversity gain. The signal Sᵢ (where i=1, 2, . . . , 180) output from the MMSE unit 617 is a scalar. The decoder 619 decodes the signal output from the MMSE unit 617 using a decoding scheme corresponding to a coding scheme used in the signal transmission apparatus, to thereby restore the signal to the original common control information.

As is apparent from the foregoing description, according to exemplary embodiments of the present invention, all BSs of the communication system transmit the common control information using the same subcarrier allocation pattern, or the M-PUSC scheme, thereby contributing to improvement in ICI cancellation performance based on the repetitive code-MMSE scheme. In addition, the M-PUSC scheme for transmission of the common control information allocates subcarriers per OFDMA symbol, contributing to an increase in flexibility of system operation. Further, relative positions of the repeated common control information are always constant, and are distributed over the entire frequency band used in the communication system, thus making it possible to acquire diversity gain.

While the invention has been shown and described with reference to a certain exemplary embodiment thereof, it will be understood by those skilled in the art that various changes in form and details may be made therein without departing from the spirit and scope of the invention as defined by the appended claims and their equivalents.

What is claimed is:

1. A method to transmit a signal in a base station (BS) of a communication system, the method comprising:
generating repetitive information by repeating information a number of times;
allocating a subcarrier for transmitting the repetitive information using a subcarrier allocation scheme that all BSs included in the communication system use in a same way; and
transmitting the repetitive information using the allocated subcarrier.

2. The method of claim 1, wherein the generating of the repetitive information comprises:
when the information includes first information and second information, repeating the first information M times and repeating the second information N times.

3. The method of claim 2, wherein the allocating of the subcarrier comprises:
allocating a subcarrier over which the M-times repeated first information is to be transmitted, as a subcarrier corresponding to a preset subcarrier index among subcarriers included in a first symbol;
re-assigning subcarrier indexes for subcarriers except for the allocated subcarrier among the subcarriers included in the first symbol;
generating N segments using the subcarriers re-assigned the subcarrier indexes;
allocating a subcarrier so that the second information is transmitted over a first segment among the N segments; and
allocating a subcarrier so that same information as the information allocated to the first segment is transmitted over each of segments except for the first segment among the N segments.

4. The method of claim 3, further comprising:
generating N segments using subcarriers included in a second symbol when it is not possible to transmit all of the second information over the first segment in course of allocating a subcarrier so that the second information is transmitted over the first segment among the N segments;
allocating a subcarrier so that remaining information except for the information to be transmitted over the first segment of the first symbol among the second information is transmitted over a first segment among N segments included in the second symbol; and
allocating a subcarrier so that same information as the information allocated to the first segment of the second symbol is transmitted over each of remaining segments except for the first segment among the N segments included in the second symbol.

5. The method of clam 1, wherein the generating of the repetitive information comprises:
when the information includes a Frame Control Header and a MAP, repeating the FCH 4 times and repeating the MAP R times.

6. The method of claim 5, wherein the allocating of the subcarrier comprises:
when one slot includes 48 subcarriers, allocating a subcarrier so that symbols of an i^{th} slot (i=0, 1, 2, 3) of the FCH are sequentially transmitted over subcarrier indexes Ndata_subcarriers/4*i through Ndata_subcarriers/4*i+47 among subcarriers included in the first symbol;
re-assigning subcarrier indexes for subcarriers except for the allocated subcarrier among the subcarriers included in the first symbol;
generating R segments using the subcarriers re-assigned the subcarrier indexes;
allocating a subcarrier so that the MAP information is transmitted over a first segment among the R segments; and
allocating a subcarrier so that same information as the information allocated to the first segment is transmitted over each of remaining segments except for the first segment among the R segments.

7. The method of claim 6, further comprising:
generating R segments using subcarriers included in a second symbol when it is not possible to transmit all of the MAP information over the first segment in course of allocating a subcarrier so that the MAP information is transmitted over the first segment among the R segments;
allocating a subcarrier so that remaining information except for the information to be transmitted over the first segment of the first symbol among the MAP information is transmitted over a first segment among R segments included in the second symbol; and
allocating a subcarrier so that same information as the information allocated to the first segment of the second symbol is transmitted over each of remaining segments except for the first segment among the R segments included in the second symbol.

8. An apparatus to transmit a signal of a base station (BS) in a communication system, the apparatus comprising:
a repetitive information generator to generate repetitive information by repeating information a number of times;
a subcarrier allocator to allocate a subcarrier for transmitting the repetitive information using a subcarrier allocation scheme that all BSs included in the communication system use in a same way; and
a transmitter to transmit the repetitive information using the allocated subcarrier.

9. The apparatus of claim 8, wherein when the information comprises first information and second information, the repetitive information generator repeats the first information M times and repeats the second information N times.

10. The apparatus of claim 9, wherein the subcarrier allocator allocates a subcarrier over which the M-times repeated first information is to be transmitted, as a subcarrier corresponding to a preset subcarrier index among subcarriers included in a first symbol, re-assigns subcarrier indexes for subcarriers except for the allocated subcarrier among the subcarriers included in the first symbol, generates N segments using the subcarriers re-assigned the subcarrier indexes, allocates a subcarrier so that the second information is transmitted over a first segment among the N segments, and allocates a subcarrier so that same information as the information allocated to the first segment is transmitted over each of segments except for the first segment among the N segments.

11. The apparatus of claim 10, wherein the subcarrier allocator generates N segments using subcarriers included in a second symbol when it is not possible to transmit all of the second information over the first segment in course of allocating a subcarrier so that the second information is transmitted over the first segment among the N segments, allocates a subcarrier so that remaining information except for the information to be transmitted over the first segment of the first symbol among the second information is transmitted over a first segment among N segments included in the second symbol, and allocates a subcarrier so that same information as the information allocated to the first segment of the second symbol is transmitted over each of remaining segments except for the first segment among the N segments included in the second symbol.

12. The apparatus of clam 8, wherein when the information comprises a Frame Control Header and a MAP, the repetitive information generator repeats the FCH 4 times and repeats the MAP R times.

13. The apparatus of claim 12, wherein the subcarrier allocator, when one slot includes 48 subcarriers, allocates a subcarrier so that symbols of an i^{th} slot (i=0, 1, 2, 3) of the FCH are sequentially transmitted over subcarrier indexes Ndata_subcarriers/4*i through Ndata_subcarriers/4*i+47 among subcarriers included in the first symbol, re-assigns subcarrier indexes for subcarriers except for the allocated subcarrier among the subcarriers included in the first symbol, generates R segments using the subcarriers re-assigned the subcarrier indexes, allocates a subcarrier so that the MAP information is transmitted over a first segment among the R segments, and allocates a subcarrier so that same information as the information allocated to the first segment is transmitted over each of remaining segments except for the first segment among the R segments.

14. The apparatus of claim 13, wherein the subcarrier allocator generates R segments using subcarriers included in a second symbol when it is not possible to transmit all of the MAP information over the first segment in course of allocating a subcarrier so that the MAP information is transmitted over the first segment among the R segments, allocates a subcarrier so that remaining information except for the information to be transmitted over the first segment of the first symbol among the MAP information is transmitted over a first segment among R segments included in the second symbol, and allocates a subcarrier so that same information as the information allocated to the first segment of the second symbol is transmitted over each of remaining segments except for the first segment among the R segments included in the second symbol.

15. A method for receiving a signal in a mobile station (MS) of a communication system, the method comprising:
when the communication system includes a serving base station (BS) and one interference BS, detecting R-times repeated information from a corresponding subcarrier of a signal received via K reception antennas;
estimating a channel using the received signal;
reassembling the detected information; and
performing R×2×k Minimum Mean Square Error (MMSE) processing on the reassembled information using the channel-estimated value.

16. The method of claim 15, wherein the R-times repeated information is allocated to a corresponding subcarrier and transmitted according to a subcarrier allocation scheme that the serving BS and the interference BS use in a same way.

17. An apparatus to receive a signal in a mobile station (MS) of a communication system, the apparatus comprising:
an information detector to, when the communication system includes a serving base station (BS) and one interference BS, detect R-times repeated information from a corresponding subcarrier of a signal received via K reception antennas;
a channel estimator to estimate a channel using the received signal;
an information reassembler to reassemble the detected information; and
an Minimum Mean Square Error (MMSE) unit to perform R×2×k MMSE processing on the reassembled information using the channel-estimated value.

18. The apparatus of claim 17, wherein the R-times repeated information is allocated to a corresponding subcarrier and transmitted according to a subcarrier allocation scheme that the serving BS and the interference BS use in a same way.
